(19) United States
(12) Patent Application Publication
(10) Pub. No.: US 2014/0278517 A1
(43) Pub. Date: Sep. 18, 2014

(54) Software Application of Implementing Dynamic Graph Analysis to Organize Clinical Entities

(71) Applicants: Ashish C. PATEL, Houston, TX (US); Frederick Clayton TROTTER, Houston, TX (US); Richard Matthew Trotter, Houston, TX (US)

(72) Inventors: Ashish C. PATEL, Houston, TX (US); Frederick Clayton TROTTER, Houston, TX (US); Richard Matthew Trotter, Houston, TX (US)

(21) Appl. No.: 14/218,967

(22) Filed: Mar. 18, 2014

Related U.S. Application Data
(60) Provisional application No. 61/794,331, filed on Mar. 15, 2013.

(51) Int. Cl. G06Q 10/06; G06Q 50/22

(52) U.S. Cl. CPC G06Q 10/0637; G06Q 50/22
USPC 705/2

(57) ABSTRACT

A software application that displays clinical entities and the relationships between them allows a user to perform a dynamic graph analysis. A data repository contains information on different clinical entities and the relationships between those clinical entities. The user can select an initial set from those clinical entities and can select a comparison set from those clinical entities. The selected clinical entities are displayed as nodes on a graphic user interface (GUI), and their relationships are displayed as links amongst those nodes on the GUI. The user can graphically rearrange the nodes through the GUI in order to reveal patterns and optimizations amongst those nodes. The software application also graphically integrates organization features into the GUI, which allows the user to further analyze the nodes.

The current application claims a priority to the U.S. Provisional Patent application Ser. No. 61/794,331 filed on Mar. 15, 2013. The current application is filed on Mar. 18, 2014 while Mar. 15, 2013 was on a weekend. The next business day is Mar. 18, 2014 while Mar. 16, 2014 was a weekend and Mar. 17, 2014 occurred when the USPTO was closed due to inclement weather.

### FIELD OF THE INVENTION

The present invention relates generally to a method and system for an application. More specifically, the present invention is a method and system for an application for using dynamic graph analysis to organize clinical entities in order to optimize clinical and financial outcomes and geographic optimization.

### BACKGROUND OF THE INVENTION

The general nature of the problem is that healthcare-related entities lack clarity in their operations. Healthcare provider networks lack the tools to evaluate the cost of integrating specific provider entities into their organization, while simultaneously lack the capacity to evaluate the members to their organization they lose efficiency working with. With other records, crude reporting tools can deliver such relationship information, but in formats that are overly verbose and difficult to take action with. It is therefore an object of the present invention to introduce a method and apparatus for using dynamic graph analysis to organize clinical entities in order to optimize clinical and financial outcomes and geographic optimization. The present invention creates a solution to condense millions of such records into a user interface that permits the user to interact with the data. The result is an environment in which financial, operational, and geospatial relationships can be modeled.

### SUMMARY OF THE INVENTION

The present invention is a software-implemented method of using graph data, which is nodes and edges, such that clinical, social, financial, and geospatial relationships are embedded in the display of the graph. Consequently, the actual design of the network enforces the given optimization using minimal interaction from the user.

The underlying data structure to model healthcare relationships begins as merely a set of relationships between entities (nodes in the graph) and links which represent the relationship between the entities. These links can be directed and weighted. With that data structure as a basis, the graphic user interface (GUI) for the present invention can model out higher level problems with either node or link “decoration”. The node or link decoration generally refers to properties of the representations of the nodes or links in the GUI.

These “decorations” can include display details and GUI interaction elements associated with the node. For example, the node decoration could be the size of the node, the color of the node, the rate at which the node moves towards a central point of gravity, or having nodes trapped into a particular part of the interface (reflecting an entity's state), the degree to which nodes repel (seek to occupy space away from) other nodes, data displayed on the basis of user actions like mouse-over's or clicks. These decorations can also center on the display of the edges, including the color, thickness, or bend of the node, or the way that the edges limit the movement of the nodes, or the way that edges themselves are bent or deformed to avoid or seek either different areas of the display.

These elements, when combined together with data from the underlying graph model of the relationships between clinical entities, will allow the user to move nodes and edges in ways that allow for complex clinical, financial, and geographic optimizations to automatically occur. These financial components include the detection of fraudulent or counterproductive business practices.

In addition, as the user interacts with the graph GUI, the underlying data model will record the meaning that the user is adding directly to the underlying graph data structure. In this way, future interactions with the graph can be informed such that “decorations” to the graph GUI will embed data from interactions that the user had with previous versions of the graph. For instance, users can move nodes into areas of the interface to label them as having a particular financial relationship with a given organization. By moving the nodes in this way, the optimal future partnerships will be automatically displayed by the graph GUI.

Users can select groups of nodes and then add data to them. For instance, you could add data to nodes which might include which electronic healthcare record (EHR) or health information exchange (HIE) vendor the entity works with. This can also be accomplished by moving the node into a particular area (FIG. 5). When this type of data is entered the graph GUI will automatically display which nodes that would be most profitable or clinically valuable to perform data integration activities with.

Users can display the graph GUI in such a way that the strength of the relationship between the entities based on some criteria determines some decoration (like the size of the node or the length of the edge) which will display the degree to which entities cooperate to deliver care.

These methods can be used together or separately. This way, a single graph could make determinations about which entities (doctors, hospitals, labs, etc.) would be most financially or clinically or socially profitable to integrate with.

Elements of the graph as a whole can be modified en masse in order to re-prioritize the layout in order to reveal different balances of motivations. For instance, the gravity or node repulsion could be modified to optimize a graph for geography over financial issues, or EHR vendor over HIE vendor.

The graph GUI would be capable of adding to the base graph data structure by adding and labeling different edges between nodes or by adding data directly to a given node.

While the healthcare system is a graph (a series of healthcare entities that cooperate to various degrees with other healthcare entities that can be represented using nodes and edges) any given single graph data set representing that will have different notations. For instance, a graph obtained via an analysis of Medicare claim data will have a different graph notation and details that one obtained using geo-spatial analysis (who is close to each other). Moreover, as a side effect of using the present invention, new graph data with new edge details will be developed.

The GUI can be capable of displaying and compensating for these different types of edges and even different meanings of nodes. Nodes might appears as sub-nodes of each other (circles inside another circle perhaps) or they might be clustered in order to represent sameness (i.e. different hospitals with different NPI's but the same EIN, or doctors that work in a in a particular hospital, displayed in a cluster). The GUI can use different styles colors or “springiness” of edges to indicate different types of edges in the underlying data set.

All with the intention that some optimization that would otherwise be impossible to either model or optimize without having the data modeled specifically as a graph with specific elements of the graph representing specific details of how the underlying clinical, social, financial or geospatial relationship functions. Additional priorities, including subsets of these general priorities, can be effectively modeled using this method. For instance, one embodiment might optimize the patient flow required to ensure that smoking cessation programs (a subset of an overall clinical benefit) are more consistently adhered to by patients using the system.

These graphs will change as the healthcare moves forward over time. Users will be able to use the GUI to see how their interventions at different points in time impact the structure of the underlying graph.

### BRIEF DESCRIPTION OF THE DRAWINGS

FIG. 1 is an illustration of the clinical entities and their relationships being diagramed by interactive user-interface elements, such as circles. The circles can be graphically rearranged to reflect organizational details that are not captured in the data used to derive the graph. By moving the nodes in the graph, the user is effectively modeling alternative organizations in order to affect organizational efficiency of the clinical entities.

FIG. 2 is an illustration that shows the set of data inputs required to illustrate FIG. 1.

FIG. 3 is a flowchart that shows the underlying changes in the data that occur when a user interacts with the graph.

FIG. 4 is a flowchart illustrating how an organization can select clinical entities that they would like to target for some purpose.

FIG. 5 is a flowchart illustrating how the users affect the stored data by interacting with the graph.

FIG. 6 is an annotated illustration explaining how to analyze a graph of clinical entities, wherein the blue nodes are the source group, and the orange nodes are hospitals.

FIG. 7 is an annotated illustration explaining how to analyze a graph of clinical entities, wherein the blue nodes are the source group, and the orange nodes are hospitals.

FIG. 8 is an annotated illustration explaining how to analyze a graph of clinical entities, wherein the different colored nodes represent a kind of clinical entity.

### DETAILED DESCRIPTION OF THE INVENTION

All illustrations of the drawings are for the purpose of describing selected versions of the present invention and are not intended to limit the scope of the present invention.

The present invention is a software application for implementing dynamic graph analysis to organize clinical entities. These clinical entities can be, but are not limited to, hospitals, specialty physicians, medical practices, laboratories, and pharmacies. The present invention allows a user to dynamically interact with a visual representation of the clinical entities and the relationships between them. The present invention allows the user to organize the visual representation in order to find clinical, social, financial, and geospatial optimizations or problems within a particular cluster of clinical entities. The present invention is provided with a data repository to store detailed information about each of the clinical entities and the relationships amongst the clinical entities.

The present invention follows a general process that allows the user to visually arrange clinical entities into alternative configurations. The general process begins by prompting the user to select a desired group from the clinical entities so that the user can visually analyze the desired group on an interactive window. The desired group is any combination of clinical entities from the data repository that the user wants to analyze with the present invention. The interactive window is a graphic user interface (GUI) that allows the user to view and interact with the visual representation or graph of the clinical entities within the desired group. The present invention will display a plurality of nodes on the interactive window, and each of these nodes will graphically represent a corresponding clinical entity within the desired group. In the preferred embodiment of the present invention, the nodes will appear as circle-shaped dots on the interactive window. In addition, the present invention will display at least one node decoration for each of the nodes on the interactive window. A node decoration will graphically represent a property of its corresponding clinical entity. The node decoration can be, but is not limited to, the size of a node, the color of a node, the edges of a node, having a node trapped in a designated section of the interactive window, and the data displayed when a mouse pointer selects or graphically rolls over a node. The property of a clinical entity is a piece of descriptive or statistical information associated with the clinical entity such as the kind of clinical entity, incoming traffic data, or outgoing traffic data. The present invention will also display a plurality of links amongst the nodes on the interactive window, and each of these links will graphically represent a corresponding relationship between two clinical entities within the desired group. In the preferred embodiment, the links will appear as lines being connected between nodes on the interactive window. Furthermore, the present invention will display at least one link decoration from each of the links on the interactive window. A link decoration will graphically represent a property of its corresponding relationship. The link decoration can be, but is not limited to, the width of a link, the length of a link, the color of a link, the curvature of a link, the edges of a link, and the data displayed when a mouse pointer selects or graphically rolls over a link. The property of a relationship is a piece of descriptive or statistical information associated with the relationship such as the traffic flow rate between two clinical entities or the kind of data transferred between two clinical entities.

The general process of the present invention continues by allowing the user to interact the nodes and the links amongst those nodes. Thus, the present invention graphically integrates a plurality of organizational features into the interactive window. Each of the organizational features can be used to collectively orient or arrange the nodes and the link in some manner. The present invention also prompts the user to graphically rearrange the nodes on the interactive window in order to visually identify the relation patterns amongst the nodes. For this step of the general process, the present invention allows the user to individually orient or arrange the nodes and the links in some manner. More specifically for this step, the present invention will prompt the user to graphically reposition a specific node onto any area of the interactive window. If the user chooses to move the specific node across the interactive window, then the present invention will receive a relocation command for the specific node through the interactive window. Finally, the present invention will execute the relocation command in order to move the specific node to a specific node on the interactive window. In one embodiment, the relocation command can be received and executed by a user clicking on the specific node with a mouse pointer and dragging the specific node to a new area on the interactive window. In another embodiment, the relocation command can be received and executed by a user clicking on the specific node with a touchscreen and moving the specific node to a new area on the interactive window with the touchscreen.

The present invention is used to graphically analyze the desired group selected in the general process. In order for the user to select the desired group, the present invention will prompt the user to select an initial set of clinical entities from the data repository, and the initial set of clinical entities need to share a common identifier. The common identifier can be, but is not limited to, any of the following: physical address relationships; geographical relationships; a shared phone/fax number; a shared email/direct address; a shared internet protocol (IP) or domain names; or an underlying property such as an affiliation with a given procedure, an affiliation with a give medication, and an affiliation/membership/partnership with a given organization or entity. Moreover, the initial set of clinical entities is an arbitrary set of starting nodes, from which the entire healthcare system could be depicted in the perspective of those starting nodes. The present invention will then prompt the user to select at least one comparison set of the clinical entities from the data repository, and the comparison set of clinical entities should also share a common identifier amongst them. Finally, the present invention will display the initial set and the comparison set as the desired group on the interactive window.

A node decoration is used to depict some property or quality for each node on the interactive window. One example is using a visual characteristic as a node decoration in order to differentiate between the initial set of clinical entities and the comparison set of clinical entities within the desired group. In this example, the present invention will display the corresponding nodes of the initial set with a first visual characteristic on the interactive window, and the present invention will display the corresponding nodes of the comparison set with a second visual characteristic on the interactive window. More specifically, the first visual characteristic and the second visual characteristics can be, but are not limited to, two different colors, two different shapes, having two different labels, or having two different icons. Another example is using a visual size as a node decoration in order to differentiate between a node with more incoming traffic and a node with less incoming traffic on the interactive window. Typically, the data repository provides an incoming traffic value for each of the clinical entities. The incoming traffic value is an accumulated number of incoming interactions that a specific clinical entity had with other clinical entities. In this example, the present invention proportionately depicts the incoming traffic value for each of the clinical entities on the interactive window by graphically adjusting the visual size for each of the nodes. Consequently, a node with a larger visual size corresponds to a clinical entity with a larger incoming traffic value, and a node with a smaller visual size corresponds to a clinical entity with a smaller incoming traffic value.

A link decoration is used to depict some property or quality for each link on the interactive window. One example is using a visual thickness as a link decoration in order to differentiate between a link with more traffic flow and a link with less traffic flow. Typically, the data repository provides a traffic flow value for each of the relationships amongst the clinical entities. The traffic flow value is an accumulated number of interactions between a particular pair of clinical entities. In this example, the present invention proportionately depicts the traffic flow value for each of said relationships on the interactive window by graphically adjusting the visual thickness of each of links. Thus, a link with a larger visual thickness corresponds to a relationship between two clinical entities with a larger traffic flow value, and a link with a smaller visual thickness corresponds to a relationship between two clinical entities with a smaller traffic flow value. Another example is using a visual length as a link decoration in order to differentiate between a closer clinical integration between two clinical entities. More specifically, if two clinical entities use the same electronic health records (EHR), then their corresponding link would have a shorter visual length than the corresponding link between two clinical entities that do not share EHR.

The present invention implements the plurality of organizational features in order to reveal clinical, financial, and geographic optimizations through the arrangement of the nodes and the links on the interactive window. One such organizational feature is a repulsion algorithm, which forces the nodes to avoid occupying the same space on the interactive window. The present invention will prompt the user to select a charge degree for the nodes. The charge degree defines by how much each node is willing to avoid occupying the same space as the other nodes. In the preferred embodiment of the present invention, the repulsion algorithm and the charge degree allow the nodes to simulate electrostatic interaction between particles of the same charge. The present invention will then compute a spatial distribution amongst the nodes by applying the repulsion algorithm with the charge degree to each of the nodes. The spatial distribution defines the collective arrangement of the nodes within the space of the interactive window. Consequently, the repulsion algorithm generates a denser spatial distribution amongst the nodes when the user selects a smaller charge degree and generates a sparser spatial distribution amongst the nodes when the user selects a larger charge degree. Finally, the present invention will display the calculated spatial distribution amongst the nodes on the interactive window.

Another such organizational feature is a spring algorithm, which forces more interconnected nodes to stay closer together on the interactive window. As previously mentioned, the data repository needs to contain a traffic flow value for each of the relationships amongst the clinical entities. The present invention will prompt the user to select an attraction degree for the links. The attraction degree defines by how much each link between two nodes is willing to keep those two nodes close each other on the interactive window. In the preferred embodiment of the present invention, the spring algorithm and the attraction degree allow a link between two nodes to simulate the physical properties of a spring with a particular stiffness. The present invention will then compute a spatial length for each of the links by applying the spring algorithm to the traffic flow value weighted with the attraction degree for each of the links. The spatial length of a specific link defines the strength of the relationship between two clinical nodes. Thus, the spring algorithm allows for more change in the spatial length for a specific link when the user selects a smaller attraction degree and allows for less change in the spatial length for a specific link when the user selects a larger attraction degree. In addition, the spring algorithm allows for more change in the spatial length for a specific link when the specific link is associated with a smaller traffic flow value and allows for less change in the spatial length for a specific link when the specific link is associated with a larger traffic flow value. At the end, the present invention will display the calculated spatial length for each of the links on the interactive window.

Another such organizational feature is a gravity algorithm, which forces nodes to move towards a given region on the interactive window. As previously mentioned, the data repository needs to contain an incoming traffic value for each of the clinical entities. The present invention will prompt the user to select a desired section on the interactive window. The desired section is an area on the interactive window that the nodes will be pulled towards. In the preferred embodiment of the present invention, the gravity algorithm and the desired region allows the nodes to simulate satellites gravitating towards a large body of mass. The present invention will then compute a spatial relocation for each of the nodes by applying the gravity algorithm with respect to the desired location to the incoming traffic value for each of the nodes. The spatial relocation is computed to move the nodes towards the desired section and is weighted by the incoming traffic value for each of the nodes. The gravity algorithm allows for a larger spatial relocation for a specific node when the specific node has a smaller incoming traffic value and allows for a smaller spatial relocation for a specific node when the specific node has a larger incoming traffic value. Finally, the present invention will display the spatial relocation for each of the nodes on the interactive window.

Another such organizational feature is a process that allows the nodes gravitate amongst each other instead of towards a specific region. As previously mentioned, the data repository needs to contain identifiers for each of the clinical entities. Again, identifiers are any piece of information that describes a clinical entity. The present invention will graphically cluster specific nodes on the interactive window if the clinical entities that correspond to those specific nodes share a common identifier. The present invention will need to search through the data repository in order determine which of the nodes has a common identifier.

Another such organizational feature is a process that allows specific nodes to be organized into a designated section of the interactive window. The designated section is used to visually group those specific nodes so that the user can see optimizations or patterns being formed amongst the other nodes on the interactive window. The present invention begins by displaying the designated section on the interactive window. The designated section can be defined by prompting the user to graphically position the designated section on the interactive window or can be pre-defined by the present invention or any other means. The present invention will then prompt the user to select the specific nodes in order to graphically relocate those specific nodes within the designated section of the interactive window. In one embodiment, the present invention will allows the user to trap those specific nodes within the designated section while the user graphically moves the other nodes across the interactive window. This embodiment graphically restrains the specific nodes within the designated section as other nodes are graphically moved about the interactive window. In addition, this embodiment graphically returns the specific nodes back to the designated section, if any of the specific nodes are graphically pulled out of the designated section by user interaction.

The present invention implements a plurality of ancillary features in order to further analyze the arrangement of the nodes and the links on the interactive window. One such ancillary feature allows the user to visually locate and select a group of nodes on the interactive window so that the user can add some kind of common data to that group of nodes. Thus, the present invention will specifically prompt the user to add common data to a specific group of nodes on the interactive window. The specific group of nodes can be selected by the user or can be pre-selected by the present invention or some other means. The present invention will then locate the clinical entities corresponding to the specific group of nodes within the data repository and will proceed to store the common data with those clinical entities. Another such ancillary feature allows the user to view detailed information for a specific clinical entity. Consequently, the present invention prompts the user to view the detailed information on a specific node through the interactive window. The detailed information can be, but limited not limited to, descriptive and/or statistical data about the clinical entity that corresponds with the specific node. The present invention will then retrieve this detailed information from the data repository and display the detailed information on the interactive window.

Another such ancillary feature allows the user to capture the current layout of the interactive window. Thus, the present invention will prompt the user to save the specific screenshot of the interactive window. Once the user agrees to save the specific screenshot, the present invention will record the current spatial distribution of the nodes and the links as the specific screenshot. The present invention will provide the user with the option to create annotations for the current spatial distribution of the nodes and links. These annotations are saved into the specific screenshot. The present invention will also provide the user the option to record a collection of screenshots for a period of time while allowing the user to graphically rearrange the nodes on the interactive window. The present invention can then be used to display the collection of screenshots as an animation of user-implemented actions. Furthermore, the animation is used to depict the changes in the spatial distribution of the nodes and the links over the period of time.

Another such ancillary feature allows the user to capture a moving history on how the information on the data repository has changed due to the shifting market conditions. Consequently, the present invention will capture a collection of screenshots for a period of time as additions and edits are made to the data repository, which allows the user to identify changes in the clinical entities on the data repository and allows the user to identify changes in the relationships between those clinical entities. Moreover, the present invention will record the current spatial distribution of the nodes and the links for each screenshot in order to capture this moving history. The present invention can then be used to display the collection of screenshots as an animation of shifting market conditions. In addition, the animation depicts the changes in the spatial distribution of the nodes and the links over the period of time.

Further uses of the present invention:
Optimization of an Accountable Care Organization (ACO) or other capitated care models.
Enabling a salesman selling services or products to clinical entities.
Optimizing doctor networks in rural areas (geographical) to ensure that patients do not have to drive too far to get specialty care.
Determining where to invest in healthcare integration efforts.
Determining which doctors to fire or hire based on connectedness to other entities.
Determining which how doctor should split money earned using ACO or other capitation profits based on performance and the degree to which patients are kept “in the family”.
Determining where to send patients for second opinions or other non-typical referrals.
Using the network to optimize different patients attending different entities based on clinicians performance of on specific quality.
Using a set of parameters designed to enable the detection of fraud.
Using a version of the graph GUI to animate changes to the underlying system over time.

Additional abilities of the present invention:
The ability to organize entities based on the strength and aspects of their relationships in order to create plans of action.
The ability to use the interactive window to determine the highest likelihood of purchasing the user's product or service.
The ability to use the interactive window to optimize the clinical coordination of patient care.
The ability to use the interactive window to optimize the cost of care.
The ability to use the interactive window to optimize investments in interoperability solutions.
The ability to use the interactive window to optimize the availability of specialists in a particular geo-spatial area.
The ability to use the interactive window to isolate cases of fraudulent, non-compliant, or counterproductive medical claims practices.
The ability to animate the graph across a timeline to show how interventions made by the user impact the underlying system.
The ability to display large sets of data with a visually interactive system that can be web-based or app-based, and permits recording of user data as well as interaction with the underlying data set.
The ability to have additional groupings.
The ability to have a Drag and Drop Doctor Grouping.
The ability to have an Automatic Graphical Network Analysis.
The ability to click on a node to bring up the entity's page in the same window (for big screens).
The ability to remember changes made by drag and drop for one user.
The ability for the users can make annotations for every entity in the diagram.
The ability to support arbitrary groups of entities for analysis.
The ability for a method to do competitor analysis for large healthcare providers.

Although the invention has been explained in relation to its preferred embodiment, it is to be understood that many other possible modifications and variations can be made without departing from the spirit and scope of the invention as hereinafter claimed.

What is claimed is:

1. A method of implementing dynamic graph analysis to organize clinical entities by executing computer-executable instructions stored on a non-transitory computer-readable medium, the method comprises the steps of:
providing a data repository, wherein said data repository includes information on a plurality of clinical entities and relationships amongst said clinical entities;
prompting to select a desired group from said clinical entities in order to visually analyze said desired group on an interactive window;
displaying a plurality of nodes on said interactive window, wherein each of said nodes graphically represents a corresponding clinical entity within said desired group;
displaying at least one node decoration for each of said nodes on said interactive window, wherein said node decoration graphically represents a property of said corresponding clinical entity;
displaying a plurality of links amongst said nodes on said interactive window, wherein each of said links graphically represents a corresponding relationship between two clinical entities within said desired group;
displaying at least one link decoration for each of said links on said interactive window, wherein said link decoration graphically represents a property of said corresponding relationship;
graphically integrating a plurality of organizational features into said interactive window; and
prompting to graphically rearrange said nodes on said interactive window in order to visually identify relational patterns amongst said nodes.

2. The method as claimed in claim 1 comprises the steps of:
prompting to graphically reposition a specific node on said interactive window;
receiving a relocation command for said specific node through said interactive window; and
executing said relocation command in order to move said specific node to a new location on said interactive window.

3. The method as claimed in claim 1 comprises the steps of:
prompting to select an initial set of clinical entities from said data repository, wherein said initial set of said clinical entities shares a common identifier;
prompting to select at least one comparison set of clinical entities from said data repository; and
displaying said initial set and said comparison set as said desired group on said interactive window.

4. The method as claimed in claim 3 comprises the steps of:
wherein said node decoration is a visual characteristic;
displaying corresponding nodes for said initial set with a first visual characteristic on said interactive window; and
displaying corresponding nodes for said comparison set with a second visual characteristic on said interactive window.

5. The method as claimed in claim 1 comprises the steps of:
providing said data repository with an incoming traffic value for each of said clinical entities;
wherein said node decoration is a visual size; and
proportionately depicting said incoming traffic value for each of said clinical entities on said interactive window by graphically adjusting said visual size for each of said nodes.

6. The method as claimed in claim 1 comprises the steps of:
providing said data repository with a traffic flow value for each of said relationships amongst said clinical entities;
wherein said link decoration is a visual thickness; and
proportionately depicting said traffic flow value for each of said relationships on said interactive window by graphically adjusting said visual thickness for each of said links.

7. The method as claimed in claim 1 comprises the steps of:
providing a repulsion algorithm as one of said organizational features;
prompting to select a charge degree for said nodes;
computing a spatial distribution amongst said nodes by applying said repulsion algorithm with said charge degree to each of said nodes; and
displaying said spatial distribution amongst said nodes on said interactive window.

8. The method as claimed in claim 7, wherein a smaller charge degree generates a denser spatial distribution amongst said nodes according to said repulsion algorithm.

9. The method as claimed in claim 7, wherein a larger charge degree generates a sparser spatial distribution amongst said nodes according to said repulsion algorithm.

10. The method as claimed in claim 1 comprises the steps of:
providing a spring algorithm as one of said organizational features;
providing said data repository with a traffic flow value for each of said relationships amongst said clinical entities;
prompting to select an attraction degree for said links;
computing a spatial length for each of said links by applying said spring algorithm to said traffic flow value weighted with said attraction degree for each of said links; and
displaying said spatial length for each of said links on said interactive window.

11. The method as claimed in claim 10, wherein a smaller attraction degree allows for more change in said spatial length for a specific link according to said spring algorithm.

12. The method as claimed in claim 10, wherein a larger attraction degree allows for less change in said spatial length for a specific link according to said spring algorithm.

13. The method as claimed in claim 10, wherein a smaller traffic flow value allows for more change in said spatial length for a specific link according to said spring algorithm.

14. The method as claimed in claim 10, wherein a larger traffic flow value allows for less change in said spatial length for a specific link according to said spring algorithm.

15. The method as claimed in claim 1 comprises the steps of:
providing a gravity algorithm as one of said organizational features;
providing said data repository with an incoming traffic value for each of said clinical entities;
prompting to select a desired section on said interactive window;
computing a spatial relocation for each of said nodes by applying said gravity algorithm with respect to said desired section to said incoming traffic value for each of said nodes, wherein said spatial relocation is directed towards said desired section; and
displaying said spatial relocation for each of said nodes on said interactive window.

16. The method as claimed in claim 15, wherein a smaller incoming traffic value allows for a larger spatial relocation for a specific node according to said gravity algorithm.

17. The method as claimed in claim 15, wherein a larger incoming traffic value allows for a smaller spatial relocation to said desired section for a specific node according to said gravity algorithm.

18. The method as claimed in claim 1 comprises the steps of:
providing said data repository with identifiers for each of said clinical entities;
searching through said data repository in order to determine specific nodes with a common identifier; and
graphically clustering said specific nodes on said interactive window,
if said specific nodes share a common identifier.

19. The method as claimed in claim 1 comprises the steps of:
providing a designated section on said interactive window as one of said organizational features;
prompting to graphically position said designated section on said interactive window;
displaying said designated section on said interactive window; and
prompting to select specific nodes in order to graphically relocate said specific nodes within said designated section.

20. The method as claimed in claim 19 comprises the steps of:
graphically restraining said specific nodes within said designated section as other nodes are graphically moved about said interactive window; and
graphically returning said specific nodes back to said designated section,
if any of said specific nodes are graphically pulled out of said designated section.

21. The method as claimed in claim 1 comprises the steps of:
prompting to add common data to a specific group of nodes on said interactive window; and
storing said common data with clinical entities corresponding to said specific group of nodes.

22. The method as claimed in claim 1 comprises the steps of:
prompting to view detailed information on a specific node through said interactive window;
retrieving said detailed information of said specific node from said data repository; and
displaying said detailed information of said specific node on said interactive window.

23. The method as claimed in claim 1 comprises the steps of:
prompting to save a specific screenshot of said interactive window; and
recording a spatial distribution of both said nodes and said links as said specific screenshot.

24. The method as claimed in claim 23 comprises the steps of:
recording a collection of screenshots for a period of time while prompting to graphically rearrange said nodes on said interactive window; and
displaying said collection of screenshots as an animation of user-implemented actions, wherein said animation depicts changes in said spatial distribution of both said nodes and said links over said period of time.

25. The method as claimed in claim 23 comprises the steps of:
prompting to create annotations for said spatial distribution of both said nodes and said links; and
saving said annotations into said specific screenshot.

26. The method as claimed in claim 1 comprises the steps of:
capturing a collection of screenshots for a period of time as additions and edits are made to said data repository in order to identify changes in said clinical entities and changes in said relationships amongst said clinical entities;
recording a spatial distribution of both said nodes and said links for each of said plurality of screenshots; and
displaying said plurality of collection as an animation of shifting market conditions, wherein said animation depicts changes in said spatial distribution of both said nodes and said links over said period of time.
